(19) United States
(12) Patent Application Publication
(10) Pub. No.: US 2015/0219783 A1
(43) Pub. Date: Aug. 6, 2015

(54) WELL RANGING TOOL AND METHOD

(71) Applicant: Halliburton Energy Services Inc., Houston, TX (US)

(72) Inventor: Mark A. Sitka, Richmond, TX (US)

(21) Appl. No.: 14/384,348

(22) PCT Filed: Jul. 25, 2013
(86) PCT No.: PCT/US13/51969

§ 371 Date: Sep. 10, 2014

(51) Int. Cl. G01V 3/26; E21B 23/06; E21B 33/127

(52) U.S. Cl. CPC G01V 3/26; E21B 33/127; E21B 23/06

(57) ABSTRACT

A method and apparatus for active magnetic ranging. A ranging tool includes one or more current-injection electrodes, one or more field-measuring sensors, and one or more expandable isolation packers positioned above and/or below the electrodes and between the electrodes and sensors. The isolation packers stabilize the ranging tool and isolate and insulate the electrodes from the sensors. The electrodes are ideally carried on an expandable electrode packer, which insulates the electrodes, urges them into intimate contact with the earthen formation, and displaces any fluids between the electrodes and the earth.

### FIELD

The present disclosure relates generally to active magnetic ranging, and specifically to a method and apparatus for locating casing or tools within nearby wells.

### BACKGROUND

Used primarily for relief and steam-assisted gravity drainage (SAGD) wells, active alternating current (AC) magnetic ranging is a known technique that has been proven for years to have the most accuracy and the greatest range for locating nearby wellbore tubulars or tools.

One active source technique uses a downhole ranging tool in a nearby relief well with one or more downhole electrodes to inject alternating current into the earth from the nearby relief well. The casing, drill pipe or stuck tool within the target well concentrates the current and generates an electromagnetic field. Magnetometers or other sensors in the ranging tool detect the magnitude, direction, and radial gradients of the electromagnetic fields. Additionally or alternatively, perturbations of the earth's magnetostatic field caused by ferromagnetic material in a target well, by the electrical current flow within the formation, or by interaction with the electromagnetic field, are measured. A computer collects these measurements for computation of the distance and direction to the target.

This technique is suitable to run in open hole, through drill pipe, or inside nonmagnetic assemblies to measure distance and direction to a target casing, string, fish or other object in a target well. No access to the target well is required. The ranging tool may be run via standard wireline. Alternatively, in a technique known as Wellspot at the Bit (WSAB), the ranging tool is carried by a drill string and allows for logging while drilling with a minimum amount of rig downtime. WSAB is particularly suited to follow or locate and drill into a damaged target well or a target well experiencing a blowout condition.

Active AC magnetic ranging techniques may be used to, among others, drill a relief well to control a blowout, mill a window and re-enter casing subsurface after sidetracking around a fish or collapsed casing, perform subsurface re-entry and abandonment, re-enter casing below an accidental workover sidetrack, find and re-enter a deep casing stub, and intersect casing at multiple depths for remedial plugging. Active AC magnetic ranging techniques are also used to maintain separation and alignment between two or more SAGD wells.

### BRIEF DESCRIPTION OF THE DRAWINGS

Embodiments are described in detail hereinafter with reference to the accompanying figures, in which:

FIG. 1 is an elevation in cross section of an uncased relief well and a cased target well, showing a ranging tool according to an embodiment positioned within a drill string in the relief well, in an non-activated state; and

FIG. 2 is the elevation in cross section of the boreholes of FIG. 1, showing a ranging tool of a wireline embodiment positioned in the relief well, in an activated state.

### DETAILED DESCRIPTION

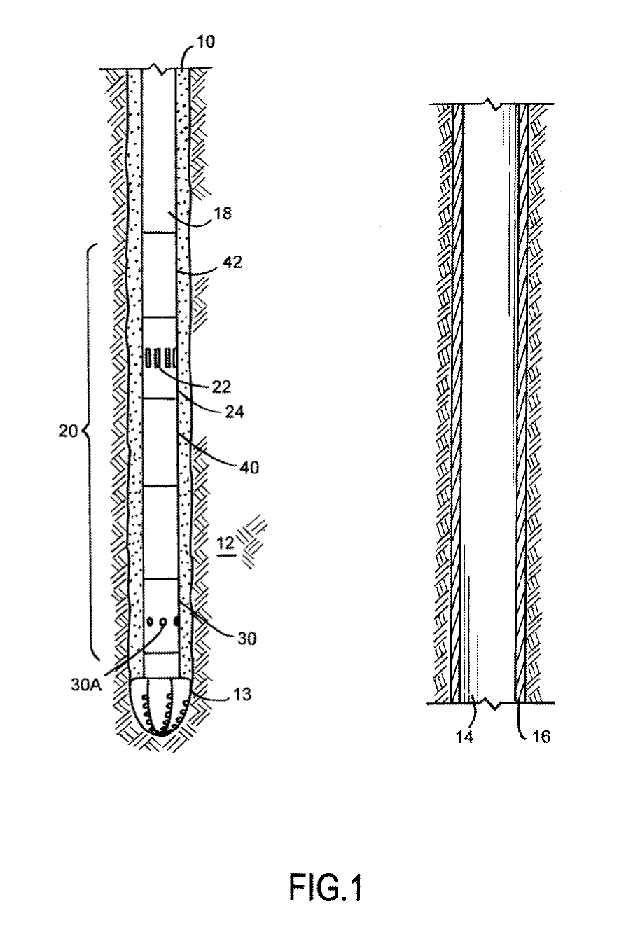

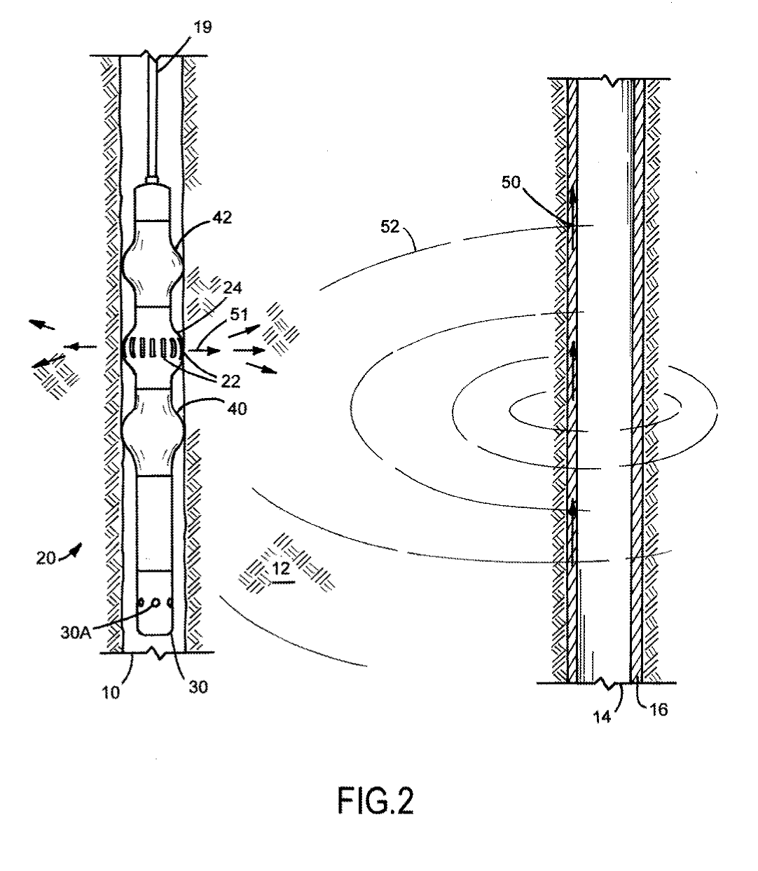

Referring to FIGS. 1 and 2, an uncased borehole 10, such as a relief well drilled or being drilled into an earthen formation 12 is shown. Nearby is a target well borehole 14, having an electrically conductive target 16 such as casing, drill pipe, or a stuck tool (not illustrated), for example, located therein.

A ranging tool 20 is lowered into borehole 10. Ranging tool may be included in a WSAB sub 30 located above a drill bit 13 and below a drill collar 18 in a drill string, as illustrated in FIG. 1. Alternatively, as shown in FIG. 2, ranging tool 20 may be adapted for running into borehole 10 via wireline 19, completion string (not illustrated), or other conveyance.

FIG. 1 illustrates ranging tool 20 in an un-activated state. In a first embodiment, ranging tool 20 includes one or more electrodes 22 that are arranged to directly contact the earthen formation 12 and one or more sensors 20 such as magnetometers for measuring an electromagnetic or magnetic field, for example. An expandable isolation packer 40 is positioned between electrodes 22 and sensors 30A. In a preferred embodiment, ranging tool 20 further includes a second expandable isolation packer 42, which is positioned so that electrodes 22 are located between isolation packers 40, 42.

Packers 24, 40, 42 are placed un a retracted state, as shown in FIG. 1, when ranging measurements are not being taken, such as during rotary drilling operations.

In one or more embodiments, electrodes 22 are carried by an expandable electrode packer 24. Electrodes 22 are preferably positioned around the outer circumference of electrode packer 24. Electrodes 22 may be formed of electrically conductive bodies located substantially externally of electrode packer 24, or they may be formed of electrically conductive bodies located at least partially within electrode packer 24 and extend through electrode packer 24 to the outer circumference to contact the earthen formation, for example.

Alternative arrangements for injecting current into the formation may also be used as appropriate. For example, than electrodes 22 being carried on an expandable electrode packer 24, one or more insulated electrode probes (not illustrated), such as a GEOTAP® probe available from the assignee of the present disclosure, may be extended to inject current into the formation and to displace mud media between the electrode and the formation.

Isolation packers 40, 42 and electrode packer 24 are preferably inflatable type packers, although any suitable packer-like assembly known to those skilled in the art may be used as appropriate. Packers 40, 42, 24 may be constructed from an elastomeric material or other suitable resilient, flexible or electrically isolated material, as is known in the art.

Referring now to FIG. 2, ranging tool 20 is shown in an activated state. Isolation packers 40, 42 are expanded so that they come into intimate contact with the earthen wall of borehole 10, thereby acting to stabilize ranging tool 20 and prevent movement of the sensitive magnetic receiving components with respect to the earthen formation.

Electrodes 22 are forced into intimate contact with the earthen formation 12 by an expanded electrode packer 24. The elastomeric or other non-conductive material of electrode packer 24 electrically insulates electrodes 22 from the collar to prevent current from interfering with sensors 30A mounted in WSAB sub 30.

The two isolation packers 40, 42 positioned above and below electrode packer 24 help to insulate the sensors 30A in WSAB sub 30 from the locally injected electrical current flowing from electrodes 22. Moreover, isolation packers 40, 42 may also eliminate the need for expensive gap subs to isolate the assembly from a traditional wireline style electrode.

In addition to urging electrodes 22 against the borehole wall and insulating electrodes 22, packer 24 also serves to displace any non-conductive drill mud or other fluid present in the borehole, and thereby improve the electrical coupling between the electrodes 22 and the formation 12 Improved electrical coupling allows current to be injected directly into the formation using a lower and more predictable voltage range resulting in less power consumption to energize the target casing or other object.

In operation, an alternating electrical current (depicted by arrows 51) is injected into earthen formation 12 via electrodes 22, as is known to routineers in the art. The current flows through the formation, and concentrates in the electrically conductive target 16 in target well borehole 14, as indicated by arrows 50. The concentrated current generates an electromagnetic field 52, which may affect the earth's magnetic field locally. The magnitude, direction, radial gradients, or other properties of electromagnetic field 52 and/or magnetic or magnetostatic fields, or other effects resulting therefrom, are sensed and measured by sensors 30, as is known in the art of active magnetic ranging, to locate, i.e., to allow calculation of direction and distance to target casing 16 or other target object. As AC magnetic ranging techniques are well known to routineers in the field, further details are not provided herein.

The Abstract of the disclosure is solely for providing the United States Patent and Trademark Office and the public at large with a way by which to determine quickly from a cursory reading the nature and gist of technical disclosure, and it represents solely one or more embodiments.

While various embodiments have been illustrated in detail, the disclosure is not limited to the embodiments shown. Modifications and adaptations of the above embodiments may occur to those skilled in the art. Such modifications and adaptations are in the spirit and scope of the disclosure.

What is claimed:

1. A method for locating an electrically conductive target within an earthen formation, comprising:
providing an electrode positioned on the outer circumference of a first packer;
positioning the first packer and the electrode within a first borehole formed in the earthen formation;
expanding said first packer so that the electrode contacts the earthen formation directly;
injecting an electrical current into the earthen formation via said electrode so as to generate a field within said earthen formation; and
measuring a property of said field by a sensor to locate the target.

2. The method of claim 1 wherein:
said target is positioned within a second borehole formed in the earthen formation.

3. The method of claim 1 further comprising:
calculating at least one from the group consisting of a distance and a direction to said target.

4. The method of claim 1 wherein:
said field is one from the group consisting of an electromagnetic field, a magnetic field, a magneto static field, an electric field, and an electrostatic field.

5. The method of claim 1 further comprising:
positioning said sensor within said first borehole;
positioning a second packer within said first borehole between said first packer and said sensor; and
expanding said second packer so that it contacts said earthen formation; whereby
said second packer is operable to isolate said first packer from said sensor.

6. The method of claim 1 further comprising:
providing a tool assembly having said first packer located thereon, said tool assembly further including a second packer positioned above said first packer and a third packer positioned below said first packer;
positioning said tool assembly within said first borehole; and
expanding said second and third packers so that they contact said earthen formation; whereby
said second and third packers are operable to stabilize said tool assembly within said first borehole.

7. The method of claim 1 further comprising:
displacing a volume of fluid from between said electrode and said earthen formation by expanding said first packer.

8. The method of claim 1 further comprising:
inflating said first packer so as to expand it.

9. The method of claim 1 wherein:
said electrical current is an alternating current.

10. A method for locating an electrically conductive target within an earthen formation, comprising:
positioning a tool assembly within a first borehole formed within said earthen formation, said tool having an electrode arranged for contacting the earthen formation and a first isolation packer;
expanding said first isolation packer so that it contacts the earthen formation;
injecting an electrical current into the earthen formation via said electrode so as to generate a field within said earthen formation; and
measuring by a sensor an effect of said field to locate said target; wherein
expanding said first isolation packer insulates and isolates said electrode from sensor.

11. The method of claim 10 further comprising:
providing a second isolation packer on said tool assembly, said electrode positioned between said first and second isolation packers; and
expanding said second isolation packer so that it contacts the earthen formation.

12. The method of claim 10 further comprising:
carrying said electrode on the outer circumference of an electrode packer; and
expanding said electrode packer so that the electrode directly contacts the earthen formation.

13. The method of claim 10 further comprising:
calculating using said measured effect of said field at least one from the group consisting of a range and a direction to said target, wherein said target is positioned within a second borehole formed in the earthen formation, and wherein said field is one from the group consisting of an electromagnetic field, a magnetic field, a magnetostatic field, an electric field, and an electrostatic field.

14. The method of claim 10 further comprising:
carrying said sensor on said tool assembly, said first isolation packer positioned between said sensor and said electrode.

15. A system for locating an electrically conductive target within an earthen formation, comprising:
an assembly arranged for downhole deployment within a first borehole formed within said earthen formation, said assembly including,
(1) an electrode arranged for directly contacting and injecting an electrical current into the earthen formation,
(2) a sensor arranged to measure an effect of one of the group consisting of an electromagnetic field, a magnetic field, a magnetostatic field, an electric field, and an electrostatic field within said earthen formation, and
(3) a first expandable isolation packer positioned between said electrode and said sensor and arranged for selective expansive so that it contacts the earthen formation, thereby isolating said electrode from said sensor.

16. The system of claim 15 wherein:
said assembly further comprises a second expandable isolation packer arranged for selective expansive so that it contacts the earthen formation, said electrode positioned between said first and second isolation packers.

17. The system of claim 15 wherein:
said assembly further comprises an expandable electrode packer carrying said electrode.

18. The system of claim 17 wherein:
said expandable electrode packer and said first expandable isolation packer are inflatable.

19. The system of claim 15 wherein:
said assembly is positioned within a drill string.

20. The system of claim 15 wherein:
said assembly is positioned within a wireline arrangement.
